(19) United States
(12) Patent Application Publication
(10) Pub. No.: US 2021/0197341 A1
(43) Pub. Date: Jul. 1, 2021

(54) COATED ABRASIVE WITH ENHANCED SUPERSIZE COMPOSITION

(71) Applicants: SAINT-GOBAIN ABRASIVES, INC., Worcester, MA (US); SAINT-GOBAIN ABRASIFS, Conflans-Sainte-Honorine (FR)

(72) Inventors: Heng ZHANG, Shanghai (CN); Tianwei Ge, Shanghai (CN)

(21) Appl. No.: 17/133,562

(22) Filed: Dec. 23, 2020

(30) Foreign Application Priority Data
Dec. 25, 2019 (CN) 201911363298.1

(51) Int. Cl. B24D 11/00; C09K 3/14

(52) U.S. Cl. CPC B24D 11/001; C09K 3/1409

(57) ABSTRACT

Systems and methods include providing a coated abrasive article with an enhanced anti-loading composition. The anti-loading composition includes a mixture of a metal stearate, at least one performance component, and optionally, a binder composition.

### CROSS-REFERENCE TO RELATED APPLICATIONS

This application claims priority to and the benefit of Chinese Patent Application No. 201911363298.1, filed on Dec. 25, 2019, by Heng ZHANG et al., entitled “COATED ABRASIVE WITH ENHANCED SUPERSIZE COMPOSITION,” the disclosure of which is assigned to the current assignee hereof and incorporated herein by reference in its entirety for all purposes.

### BACKGROUND OF THE INVENTION

Abrasive articles, such as coated abrasives, are used in various industries to prepare and condition workpieces by lapping, grinding, and polishing to achieve a desired condition (e.g., coating removal, material removal, surface roughness, gloss, transparency, etc.) of the workpiece. Such coated abrasive articles can be used in processing a wide range of materials from initial coarse material removal to high precision polishing and finishing surfaces at a submicron level. The formulation of various layers in these abrasive articles can be tailored to achieve desired aesthetic and/or performance results.

### SUMMARY

The present disclosure relates generally to coated abrasive articles that includes an anti-loading composition in a make coat, a size coat, a supersize coat, or combinations thereof, to enhance surface processing (e.g., grinding, etc.) of various workpieces. The anti-loading composition provides a higher cut rate, reduced material loading, and desired appearance as compared to traditional coated abrasive articles.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope, as there may be other equally effective embodiments.

FIG. 1 is a cross sectional view of an abrasive article according to an embodiment of the disclosure.

FIG. 2 is a flowchart of a method of forming an abrasive article according to an embodiment of the disclosure.

FIG. 3 is a flowchart of a method of forming an abrasive article according to another embodiment of the disclosure.

FIG. 4 is a chart providing comparative data of cumulative material removal of conventional abrasive articles and embodiments of abrasive articles of the disclosure.

FIG. 5 is a chart providing comparative data of cumulative material removal percentages of conventional abrasive articles and embodiments of abrasive articles of the disclosure.

FIG. 6 shows comparative microscopic images of embodiments of abrasive articles of the disclosure before testing and after testing.

FIG. 7 shows comparative surface images of a conventional abrasive article and embodiments of abrasive articles of the disclosure.

FIG. 8 shows K/S spectrum values of a colorimeter test of a conventional abrasive article and embodiments of abrasive articles of the disclosure.

FIG. 9 shows R/T spectrum values of a colorimeter test of a conventional abrasive article and embodiments of abrasive articles of the disclosure.

FIG. 10 shows shade values of an image processing test of a conventional abrasive article and embodiments of abrasive articles of the disclosure.

FIG. 11 shows delta shade values of an image processing test of a conventional abrasive article and embodiments of abrasive articles of the disclosure.

FIG. 12 shows a chart providing comparative data of cumulative material removal (CMR) versus cycles of a conventional abrasive article and an embodiment of an abrasive article of the disclosure.

FIG. 13 shows a chart providing comparative data of cumulative material removal ratio (MRR) versus cycles of a conventional abrasive article and an embodiment of an abrasive article of the disclosure.

FIG. 14 shows a chart providing comparative data of cumulative material removal (CMR) of a conventional abrasive article and embodiments of abrasive articles of the disclosure.

FIG. 15 shows a chart providing comparative data of average cumulative cut and surface roughness of a conventional abrasive article and embodiments of abrasive articles of the disclosure.

The use of the same reference symbols in different drawings indicates similar or identical items.

### DETAILED DESCRIPTION

Abrasive Article

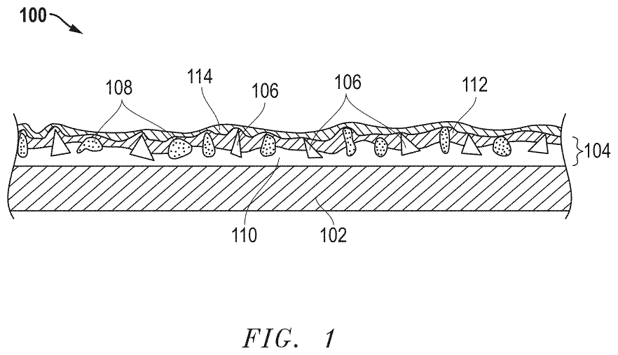

FIG. 1 shows a cross sectional view of a coated abrasive article 100 according to an embodiment of the disclosure. The coated abrasive article 100 may generally comprise a substrate (also referred to herein as a “backing material” or “backing”) 102 on which an abrasive layer 104 can be disposed. The abrasive layer 104 may include abrasive grains or particles 106 and/or aggregates 108 disposed at least partially in or on a polymeric make coat binder composition (commonly referred to as the “make coat”) 110. In some embodiments, the abrasive layer 104 may also comprise a polymeric size coat binder composition (commonly referred to as the “size coat”) 112 disposed over the abrasive particles 106, the aggregates 108, and the make coat 110. Additionally, in some embodiments, a polymeric supersize coat binder composition (commonly referred to as the “supersize coat”) 114 may be disposed over the abrasive layer 104 and the size coat 112. In some embodiments, the supersize coat 114 may comprise an enhanced anti-loading composition. However, in some embodiments, the supersize coat 114 may comprise the enhanced anti-loading composition disposed a least partially on or in (e.g., dispersed in) the supersize coat 114.

In some embodiments, the abrasive article 100 may be a fixed abrasive article. Fixed abrasive articles may include coated abrasive articles, bonded abrasive articles, nonwoven abrasive articles, engineered abrasive articles, and combinations thereof. Abrasive articles, such as abrasive article 100, may be in the form of sheets, discs, belts, tapes, wheels, thin wheels, flap wheels, flap discs, polishing films, and the like. In certain embodiments, the abrasive article 100 may be a bonded abrasive article comprising a plurality of abrasive particles 106 dispersed in a bond matrix composition. In an alternative embodiment, the abrasive article 100 may be a coated abrasive article comprising a substrate 102, a make coat 110 disposed on the substrate 102, and abrasive particles 106 and/or composite abrasive aggregates 108 disposed on or in the make coat 110. In an alternative embodiment, the abrasive article 100 may be a nonwoven abrasive article comprising a substrate 102 of nonwoven lofty fibers, a make coat 110 disposed on the substrate 102, abrasive particles 106 disposed on or in the make coat binder 110, and optionally a size coat 112 and/or a supersize coat 114.

Substrate

The substrate (also referred to herein as a “backing material” or “backing”) 102 may be flexible or rigid. The substrate 102 may be made of any number of various materials including those conventionally used as backings in the manufacture of coated abrasives. An exemplary flexible backing includes a polymeric film (for example, a primed film), such as polyolefin film (e.g., polypropylene including biaxially oriented polypropylene), polyester film (e.g., polyethylene terephthalate), polyamide film, or cellulose ester film; metal foil; mesh; foam (e.g., natural sponge material or polyurethane foam); cloth (e.g., cloth made from fibers or yarns comprising polyester, nylon, silk, cotton, poly-cotton, rayon, or combinations thereof); paper; vulcanized paper; vulcanized rubber; vulcanized fiber; nonwoven materials; a combination thereof; or a treated version thereof. Cloth backings can be woven or stitch bonded. In particular examples, the substrate 102 may be selected from the group consisting of paper, polymer film, cloth (e.g., cotton, poly-cotton, rayon, polyester, poly-nylon), vulcanized rubber, vulcanized fiber, metal foil, and a combination thereof. In other examples, the substrate 102 may include polypropylene film or polyethylene terephthalate (PET) film.

In some embodiments, the substrate 102 can optionally have at least one of a saturant, a presize layer (also called a “front fill layer”), or a backsize layer (also called a “back fill layer”). The purpose of these layers is typically to seal the substrate 102 or to protect yarn or fibers in the substrate 102. In embodiments where the substrate 102 is a cloth material, at least one of these layers is typically used. The addition of the presize layer or backsize layer can additionally result in a “smoother” surface on either the front or the back side of the substrate 102. Other optional layers known in the art can also be used such as a tie layer. In some embodiments, the substrate 102 may also be a fibrous reinforced thermoplastic such as described, for example, in U.S. Pat. No. 5,417,726 (Stout et al.), or an endless spliceless belt, as described, for example, in U.S. Pat. No. 5,573,619 (Benedict et al.). Likewise, in other embodiments, the substrate 102 may be a polymeric substrate having hooking stems projecting therefrom such as that described, for example, in U.S. Pat. No. 5,505,747 (Chesley et al.). Similarly, the substrate 102 may be a loop fabric such as that described, for example, in U.S. Pat. No. 5,565,011 (Follett et al.).

Abrasive Layer and Particles

The abrasive layer 104 may include abrasive grains or particles 106 and/or aggregates 108 disposed at least partially in or on the make coat 110. In some embodiments, the abrasive layer 104 may also comprise the size coat 112 disposed over the abrasive particles 106 and/or aggregates 108 and the make coat 110. Abrasive particles 106 may include essentially single-phase inorganic materials, such as alumina, silicon carbide, silica, ceria, and/or harder, high performance superabrasive particles such as cubic boron nitride and diamond. Further, the abrasive particles 106 may include engineered abrasives including macrostructures and particular three-dimensional structures. Aggregates 108 may comprise abrasive aggregates and/or nonabrasive aggregates. In some embodiments, aggregates 108 may include composite particulate materials, which can be formed through slurry processing pathways that include removal of the liquid carrier through volatilization or evaporation, leaving behind unfired (“green”) aggregates 108, that can optionally undergo high temperature treatment (i.e., firing, sintering) to form usable, fired aggregates 108.

The abrasive particles 106 and/or aggregates 108 may be formed of any one of or a combination of abrasive particles, including silica, alumina (fused or sintered), zirconia, zirconia/alumina oxides, silicon carbide, garnet, diamond, cubic boron nitride, silicon nitride, ceria, titanium dioxide, titanium diboride, boron carbide, tin oxide, tungsten carbide, titanium carbide, iron oxide, chromia, flint, emery. For example, the abrasive particles 106 and/or aggregates 108 may be selected from a group consisting of silica, alumina, zirconia, silicon carbide, silicon nitride, boron nitride, garnet, diamond, co-fused alumina zirconia, ceria, titanium diboride, boron carbide, flint, emery, alumina nitride, and a blend thereof. Particular embodiments have been created by use of dense abrasive particles 106 comprised principally of alpha-alumina.

In particular embodiments, the abrasive particles 106 and/or aggregates 108 may be blended with the binder formulation to form abrasive slurry. Alternatively, the abrasive particles 106 and/or aggregates 108 may be applied over the make coat 110 after the make coat 110 is applied to the substrate 102. Optionally, a functional powder can be applied over the abrasive regions to prevent the abrasive regions from sticking to a patterning tooling. Alternatively, patterns can be formed in the abrasive regions absent the functional powder.

Make Coat

The polymeric make coat binder composition 110 (commonly referred to as the “make coat”) may be formed from a single polymer or a blend of polymers. The make coat 110 may be formed from an epoxy composition, acrylic composition, a phenolic composition, a polyurethane composition, a phenolic composition, a polysiloxane composition, or combinations thereof. In some embodiments, the make coat 110 may generally include a polymer matrix, which binds abrasive particles 106 and/or aggregates 108 to the substrate 102 or to a compliant coat, if such a compliant coat is present. In some embodiments, the make coat 110 may be formed of cured binder formulation. Additionally, in some embodiments, the make coat 110 may include an anti-loading composition, one or more additives, or a combination thereof.

In some embodiments, the make coat 110 may include at least one polymer component and a dispersed phase. The make coat 110 may include one or more reaction constituents or polymer constituents for the preparation of a polymer. Suitable polymer constituents may include a monomeric molecule, a polymeric molecule, or a combination thereof. Further, the make coat 110 may further comprise components selected from the group consisting of solvents, plasticizers, chain transfer agents, catalysts, stabilizers, dispersants, curing agents, reaction mediators and agents for influencing the fluidity of the dispersion. Accordingly, in some embodiments, the polymer constituents may form thermoplastics or thermosets.

By way of example, the polymer constituents may include monomers and resins for the formation of polyurethane, polyurea, polymerized epoxy, polyester, polyimide, polysiloxanes (silicones), polymerized alkyd, styrene-butadiene rubber, acrylonitrile-butadiene rubber, polybutadiene, or, in general, reactive resins for the production of thermoset polymers. Another example includes an acrylate or a methacrylate polymer constituent. The precursor polymer constituents are typically curable organic material (i.e., a polymer monomer or material capable of polymerizing or crosslinking upon exposure to heat or other sources of energy, such as electron beam, ultraviolet light, visible light, etc., or with time upon the addition of a chemical catalyst, moisture, or other agent, which cause the polymer to cure or polymerize). A precursor polymer constituent example includes a reactive constituent for the formation of an amino polymer or an aminoplast polymer, such as alkylated urea-formaldehyde polymer, melamine-formaldehyde polymer, and alkylated benzoguanamine-formaldehyde polymer; acrylate polymer including acrylate and methacrylate polymer, alkyl acrylate, acrylated epoxy, acrylated urethane, acrylated polyester, acrylated polyether, vinyl ether, acrylated oil, or acrylated silicone; alkyd polymer such as urethane alkyd polymer; polyester polymer; reactive urethane polymer; phenolic polymer such as resole and novolac polymer; phenolic/latex polymer; epoxy polymer such as bisphenol epoxy polymer; isocyanate; isocyanurate; polysiloxane polymer including alkylalkoxysilane polymer; or reactive vinyl polymer. The binder formulation can include a monomer, an oligomer, a polymer, or a combination thereof. In a particular embodiment, the binder formulation includes monomers of at least two types of polymers that when cured may crosslink. For example, the binder formulation may include epoxy constituents and acrylic constituents that when cured form an epoxy/acrylic polymer.

Size Coat

The polymeric size coat binder composition 112 (commonly referred to as the “size coat”) may generally be a component of the abrasive layer 104 and be disposed over the abrasive particles 106, the aggregates 108, and the make coat 110. The size coat 112 may be formed in a substantially similar manner as the make coat 110. Thus, in some embodiments, the size coat 112 may be the same or different from the make coat 110. Further, size coat 112 may comprise any conventional compositions known in the art that can be used as a size coat. Still further, in some embodiments, the size coat 112 may include may include an anti-loading composition, one or more additives, or a combination thereof.

Supersize Coat

The polymeric supersize coat binder composition 114 (commonly referred to as the “supersize coat”) may generally be disposed over the abrasive layer 104, more specifically, the abrasive particles 106, the aggregates 108, the make coat 110, and the size coat 112. In some embodiments, the supersize coat 114 may be formed in a substantially similar manner as the make coat 110 and/or the size coat 112. Additionally, in some embodiments, the supersize coat 114 may comprise an enhanced anti-loading composition. However, in some embodiments, the supersize coat 114 may comprise the enhanced anti-loading composition disposed a least partially on or in (e.g., dispersed in) the supersize coat 114. Further, at least in some embodiments, the supersize coat 114 may comprise one or more additives in addition to the anti-loading composition.

Anti-Loading Composition

The anti-loading composition may generally comprise a resin binder, an anti-loading agent, and a performance component. In some embodiments, the resin binder may be a non-polymeric binder, a polymeric binder, or a combination thereof. The amount of resin binder in the anti-loading composition may vary. In some embodiments, the amount of resin binder in the anti-loading composition may be at least 0.1 wt. %, such as at least 0.3 wt. %, at least 0.5 wt. %, at least 1 wt. %, at least 2 wt. %, at least 3 wt. %, at least 4 wt. %, at least 5 wt. %, at least 6 wt. %, at least 7 wt. %, at least 8 wt. %, at least 9 wt. %, at least 10 wt. %, at least 20 wt. %, at least 25 wt. %, or at least 30 wt. %. In other embodiments, the amount of resin binder in the anti-loading composition may not be greater than 50 wt. %, such as not greater than 30 wt. %, not greater than 25 wt. %, not greater than 20 wt. %, not greater than 15 wt. %, not greater than 10 wt. %, not greater than 9 wt. %, not greater than 8 wt. %, not greater than 7 wt. %, not greater than 6 wt. %, not greater than 5 wt. %, not greater than 4 wt. %, not greater than 3 wt. %, or not greater than 2 wt. %. Further, it will be appreciated that the amount of weight of the resin binder in the anti-loading composition may be between any of these minimum and maximum values, such as at least 0.1 wt. % to not greater than 50 wt. %.

The anti-loading agent may generally be configured to decrease the adhesion of chips, pieces, or swarf of a workpiece to the abrasive article 100 during grinding, thereby reducing loading of the abrasive article 100 during grinding. In some embodiments, the anti-loading agent may comprise a metal soap, such as a metal stearate, metal stearate dispersion, a hydrate form thereof, or a combination thereof. Accordingly, in one specific embodiment, the metal stearate may comprise calcium stearate. However, in another specific embodiment, the metal stearate may comprise zinc stearate. In another specific embodiment, the metal stearate may comprise a zinc stearate dispersion. In other embodiments, the metal stearate may comprise a combination of calcium stearate and zinc stearate.

The amount of metal stearate in the anti-loading composition may vary. In some embodiments, the amount of metal stearate in the anti-loading composition may be at least 10 wt. %, such as at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, or at least 75 wt. %. In other embodiments, the amount of metal stearate in the anti-loading composition may not be greater than 99 wt. %, such as not greater than 95 wt. %, not greater than 90 wt. %, not greater than 85 wt. %, or not greater than 80 wt. %. Further, it will be appreciated that the amount of metal stearate in the anti-loading composition may be between any of these minimum and maximum values, such as at least 10 wt. % to not greater than 99 wt. %.

The performance component may generally comprise a material that enhances the appearance of the abrasive article 100, the performance of the abrasive article 100, or a combination thereof. In some embodiments, the performance component may comprise titanium dioxide (TiO₂). Accordingly in some embodiments, the titanium dioxide may increase the performance of an abrasive article 100. For example, in some embodiments, the titanium dioxide may increase cumulative material removal and/or cumulative material removal percentage as compared to a conventional abrasive article that comprises no titanium dioxide. Further, at least in some embodiments, the titanium dioxide may enhance the appearance of an abrasive article 100. For example, in some embodiments, the titanium dioxide may decrease the visibility a pattern in the abrasive article 100. Thus, in some embodiments, the supersize coat and/or the abrasive article may comprise a substantially patternless appearance. In some embodiments, a minimum of 5 grams, or even a minimum of 2 grams, of titanium dioxide may result in a patternless appearance. The patternless appearance may generally be measured by at least one of a color spectrum (colorimeter) test, an image processing test, a surface profilometer test, a shade value ((R+G+B)/3), a delta shade value ((R+G+B)/3), or alternatively, by any other known test used for surface finish, pattern, or roughness detection. Additionally, in some embodiments, the titanium dioxide may increase a white-colored appearance of an abrasive article 100. In some embodiments, a minimum of 5 grams, or even a minimum of 2 grams, of titanium dioxide may result in a white-colored appearance. Still further, an increase in the amount of titanium dioxide between embodiments may further enhance and/or increase the white-colored appearance of an abrasive article. The white-colored appearance may generally be measured by a colorimeter test, or alternatively, by any other known test used for color detection. It will be appreciated that the titanium dioxide may comprises one or more forms, including but not limited to, auatase, rutile, brookite, or any combination thereof.

The amount of titanium dioxide in the anti-loading composition may vary. In some embodiments, the amount of titanium dioxide in the anti-loading composition may be at least 0.1 wt. %, such as at least 0.5 wt. %, at least 1 wt. %, at least 2 wt. %, at least 3 wt. %, at least 4 wt. %, at least 5 wt. %, at least 6 wt. %, at least 7 wt. %, at least 8 wt. %, at least 9 wt. %, at least 10 wt. %, at least 12 wt. %, at least 13 wt. %, at least 20 wt. %, at least 23 wt. %, at least 25 wt. %, at least 27 wt. %, at least 30 wt. %, at least 33 wt. %, at least 35 wt. %, at least 37 wt. %, at least 40 wt. %, at least 50 wt. %, at least 60 wt. %, or at least 65 wt. %. In other embodiments, the amount of titanium dioxide in the anti-loading composition may be not greater than 95 wt. %, such as not greater than 90 wt. %, not greater than 85 wt. %, not greater than 80 wt. %, not greater than 75 wt. %, not greater than 74 wt. %, not greater than 73 wt. %, not greater than 72 wt. %, not greater than 71 wt. %, or not greater than 70 wt. %. Further, it will be appreciated that the amount of weight of the titanium dioxide in the anti-loading composition may be between any of these minimum and maximum values, such as at least 0.1 wt. % to not greater than 95 wt. %.

Disposition

The anti-loading composition may be present in one or more particular layers of the abrasive article 100, including the make coat 110, the size coat 112, and/or the supersize coat 114. The anti-loading composition present in one layer may be same as or different from the anti-loading composition present in another layer. In some embodiments, the anti-loading composition may be present in the make coat 110, the size coat 112, the supersize coat 114, or a combination thereof. In one specific embodiment, the anti-loading composition is dispersed in the make coat 110. In another specific embodiment, the anti-loading composition is disposed in the make coat 110 and the size coat 112. In another specific embodiment, the anti-loading composition is dispersed in the make coat 110, the size coat 112, and the supersize coat 114. In another specific embodiment, the anti-loading composition is dispersed only in the supersize coat 114.

The amount of anti-loading composition present in the supersize coat 114 may vary. In an embodiment, the anti-loading composition can comprise the entire (i.e., 100 wt. %) of the supersize coat 114. In another embodiment, the anti-loading composition can comprise only a portion of the supersize coat 114. In some embodiments, the anti-loading composition in the supersize coat 114 may be at least 0.1 wt. %, such as at least 0.5 wt. %, at least 1 wt. %, at least 5 wt. %, at least 10 wt. %, at least 15 wt. %, at least 20 wt. %, at least 25 wt. %, at least 30 wt. %, at least 35 wt. %, at least 40 wt. %, at least 50 wt. %, at least 60 wt. %, at least 70 wt. %, at least 80 wt. %, or at least 90 wt. % of the supersize coat. In some embodiments, the anti-loading composition in the supersize coat may not be greater than 99 wt. %, such as not greater than 95 wt. %, not greater than 90 wt. %, not greater than 85 wt. %, not greater than 80 wt. %, not greater than 75 wt. %, not greater than 70 wt. %, not greater than 65 wt. %, not greater than 60 wt. %, not greater than 55 wt. %, not greater than 50 wt. %, not greater than 45 wt. %, not greater than 40 wt. %, not greater than 35 wt. %, not greater than 30 wt. %, not greater than 25 wt. %, not greater than 20 wt. %, not greater than 15 wt. %, not greater than 10 wt. %, or not greater than 5 wt. %. Further, it will be appreciated that the amount of anti-loading composition present in the supersize coat 114 may be between any of these minimum and maximum values, such as at least 1 wt. % to not greater than 99 wt. %.

Additives

The make coat 110, size coat 112, and/or supersize coat 114 may include one or more additives. Additionally, the anti-loading composition may also include one or more additives. Suitable additives can include grinding aids, fibers, lubricants, wetting agents, chelating agents, thixotropic materials, surfactants, thickening agents, pigments, dyes, antistatic agents, coupling agents, plasticizers, suspending agents, pH modifiers, adhesion promoters, lubricants, bactericides, fungicides, flame retardants, degassing agents, anti-dusting agents, dual function materials, initiators, chain transfer agents, stabilizers, dispersants, reaction mediators, colorants, and defoamers. In a particular embodiment, the additive may comprise Calcium Sulfate (CaSO₄), Talc, or a combination thereof. The amounts of these additive materials can be selected to provide the properties desired. These optional additives can be present in any part of the overall system of the coated abrasive product according to embodiments of the present disclosure. Suitable grinding aids can be inorganic based; such as halide salts, cryolite, wollastonite, and potassium fluoroborate (KBF₄), or organic based, such as sodium lauryl sulphate, or chlorinated waxes, such as polyvinyl chloride. In an embodiment, the grinding aid can be an environmentally sustainable material.

The amount of additive in the anti-loading composition may vary. In some embodiments, the amount of additive in the anti-loading composition may be at least 0.1 wt. %, such as at least 0.5 wt. %, at least 1 wt. %, at least 2 wt. %, at least 3 wt. %, at least 5 wt. %, at least 7 wt. %, at least 10 wt. %, such as at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, or at least 70 wt. %. In other embodiments, the amount of additive in the anti-loading composition may not be greater than 99 wt. %, such as not greater than 95 wt. %, not greater than 90 wt. %, not greater than 85 wt. %, or not greater than 80 wt. %. Further, it will be appreciated that the amount of additive in the anti-loading composition may be between any of these minimum and maximum values, such as at least 0.1 wt. % to not greater than 99 wt. %.

Method of Forming a Coated Abrasive Article

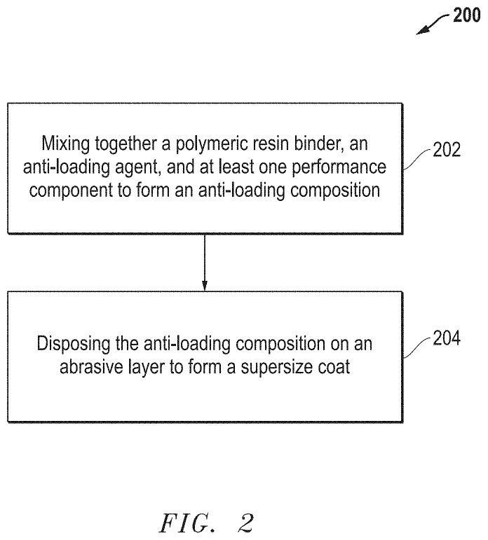

Referring now to FIG. 2, a flowchart of a method 200 of forming an abrasive article 100 according to an embodiment of the disclosure is shown. Method 200 begins at block 202 by mixing together a polymeric resin binder, an anti-loading agent, and at least one performance component to form an anti-loading composition. In some embodiments, the anti-loading agent may be optional. In some embodiments, the at least one performance component may comprise titanium dioxide (TiO₂). Method 200 may continue at block 204 by disposing the anti-loading composition on an abrasive layer 104 to form a supersize coat 114.

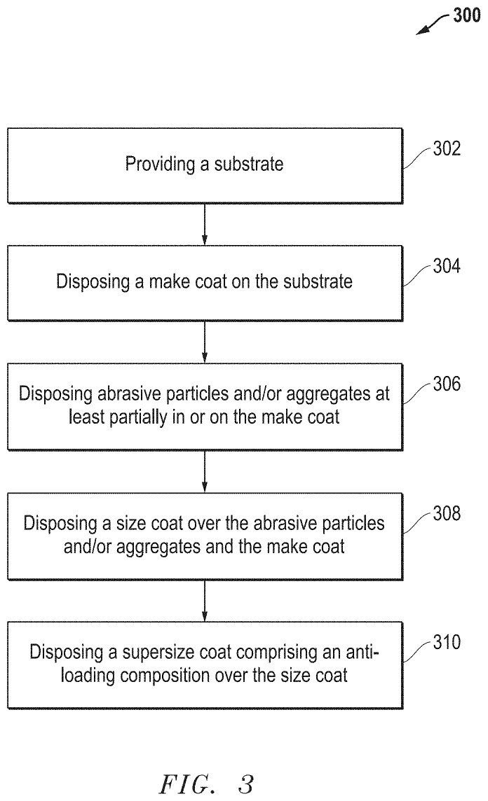

Referring now to FIG. 3, a flowchart of a method 300 of forming an abrasive article 100 according to another embodiment of the disclosure is shown. Method 300 begins at block 302 by providing a substrate 102. Method 300 may continue at block 304 by disposing a make coat 110 on the substrate 102. Method 300 may continue at block 306 by disposing abrasive particles 106 and/or aggregates 108 at least partially in or on the make coat 110. Method 300 may continue at block 308 by disposing a size coat 112 over the abrasive particles 106 and/or aggregates 108 and the make coat 110. Method 300 may continue at block 310 by disposing a supersize coat 114 comprising an anti-loading composition over the size coat 112.

### Examples

Conventional abrasive article C1 and sample abrasive articles S1 to S6 were prepared. The uncured anti-loading compositions are shown in Table 1 below.

TABLE 1
Uncured Anti-loading Composition

| | C1 | S1 | S2 | S3 | S4 | S5 | S6 |
|---|---|---|---|---|---|---|---|
| Zinc | 90 | 90 | 90 | 90 | 90 | 90 | 90 |
| Stearate¹ | | | | | | | |
| Binder¹ | 10 | 10 | 10 | 10 | 10 | 10 | 10 |
| TiO₂¹ | 0 | 2 | 5 | 7.5 | 15 | 30 | 50 |
| Zinc | 90% | 88.24% | 85.71% | 83.72% | 78.26% | 69.23% | 60.00% |
| Stearate² | | | | | | | |
| Binder² | 10% | 9.80% | 9.52% | 9.30% | 8.70% | 7.69% | 6.67% |
| TiO₂² | 0% | 1.96% | 4.76% | 6.98% | 13.04% | 23.08% | 33.33% |

¹Uncured wet weight (grams)
²Uncured wet weight percentage (%)

The cured anti-loading compositions for sample abrasive articles S1 to S6 are shown in Table 2 below.

TABLE 2
Cured Anti-loading Composition

| | C1 | S1 | S2 | S3 | S4 | S5 | S6 |
|---|---|---|---|---|---|---|---|
| Zinc | 45 | 45 | 45 | 45 | 45 | 45 | 45 |
| Stearate¹ | | | | | | | |
| Binder¹ | 4.5 | 4.5 | 4.5 | 4.5 | 4.5 | 4.5 | 4.5 |
| TiO₂¹ | 0 | 2 | 5 | 7.5 | 15 | 30 | 50 |
| Zinc | 90.91% | 87.38% | 82.57% | 78.95% | 69.77% | 56.60% | 45.23% |
| Stearate² | | | | | | | |
| Binder² | 9.09% | 8.74% | 8.26% | 7.89% | 6.98% | 5.66% | 4.52% |
| TiO₂² | 0% | 3.88% | 9.17% | 13.16% | 23.26% | 37.74% | 50.25% |

¹Cured dry weight (grams)
²Cured dry weight percentage (%)

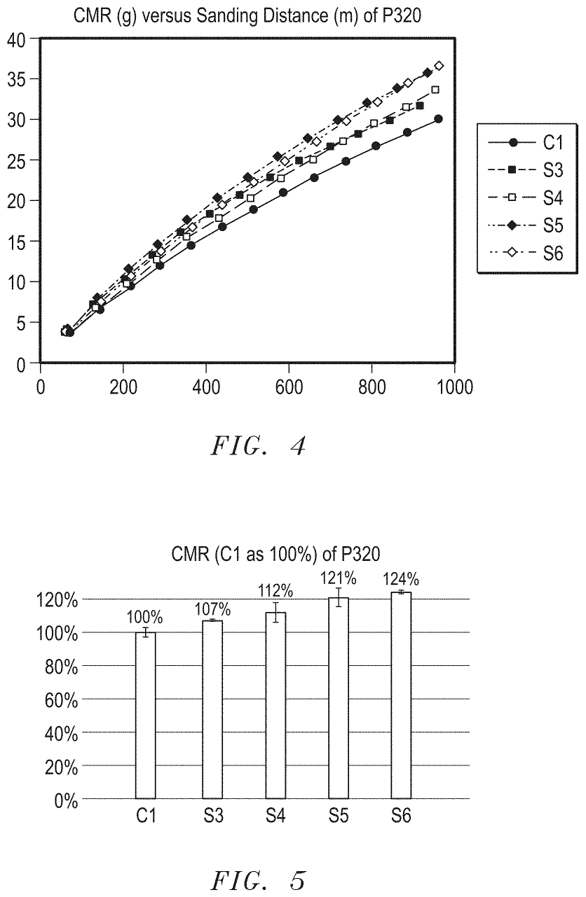

FIGS. 4 and 5 show a chart providing comparative data of cumulative material removal and cumulative material removal percentages of the conventional abrasive article (C1) and embodiments (S3 to S6) of abrasive articles 100 of the disclosure. More specifically, the charts show the respective cumulative material removal of a conventional abrasive article (C1) having no titanium dioxide (TiO₂) in their respective supersize coats versus four embodiments (S3 to S6) of abrasive articles 100 having varying amounts of titanium dioxide in their respective supersize coats. S3 includes 7.5 grams of titanium dioxide. S4 includes 15.0 grams of titanium dioxide. S5 includes 30.0 grams of titanium dioxide. S6 includes 50.0 grams of titanium dioxide. Samples having over 50.0 grams of titanium dioxide (75.0 grams and 115.0 grams, respectively) were unable to be tested because the viscosity of the supersize coat was too high. In some embodiments, more than 50 grams, or even more than 60 grams, of titanium dioxide may not be suitable for abrasive articles 100. The sample embodiments (S3 to S6) of abrasive articles 100 had higher cumulative material removal (as measured in grams) and cumulative material removal percentages as compared to the conventional abrasive article (C1), ranging from 107% for S3 to 124% for S6.

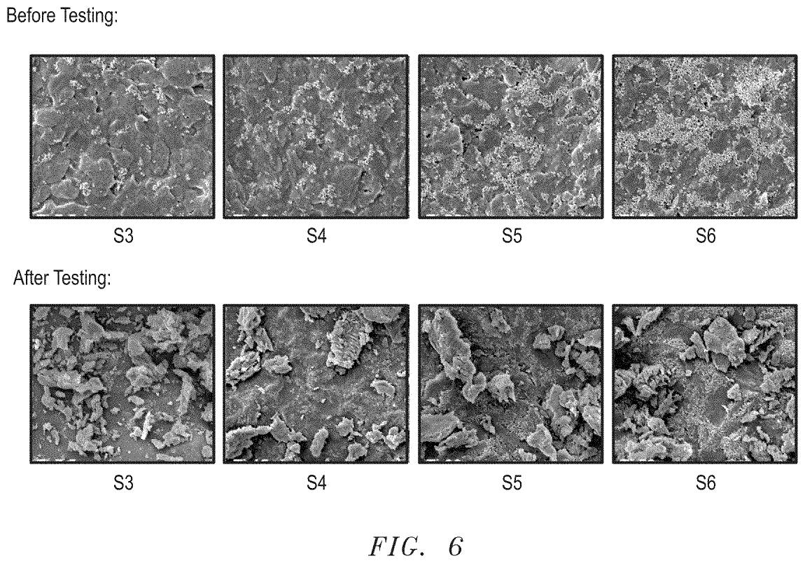

FIG. 6 shows comparative microscopic images of embodiments (S3 to S6) of abrasive articles 100 of the disclosure before testing and after testing. Surprisingly and beneficially, the regions where titanium dioxide was present in the supersize coat repelled swarf from sticking to the abrasive article 100. Accordingly, in some embodiments, the addition of titanium dioxide to a supersize coat of an abrasive article 100 may increase swarf removal and repel swarf from sticking to the abrasive article as compared to a conventional abrasive article having no titanium dioxide in the supersize coat.

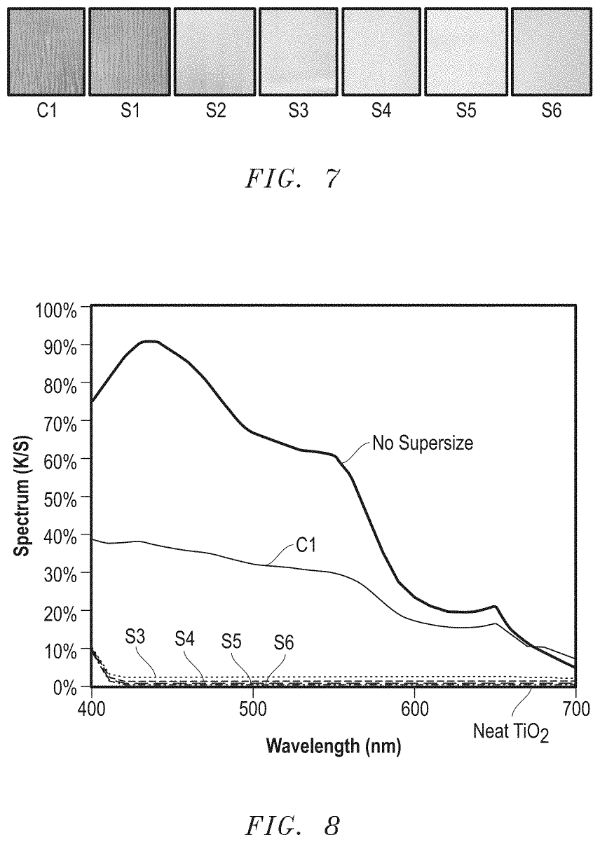

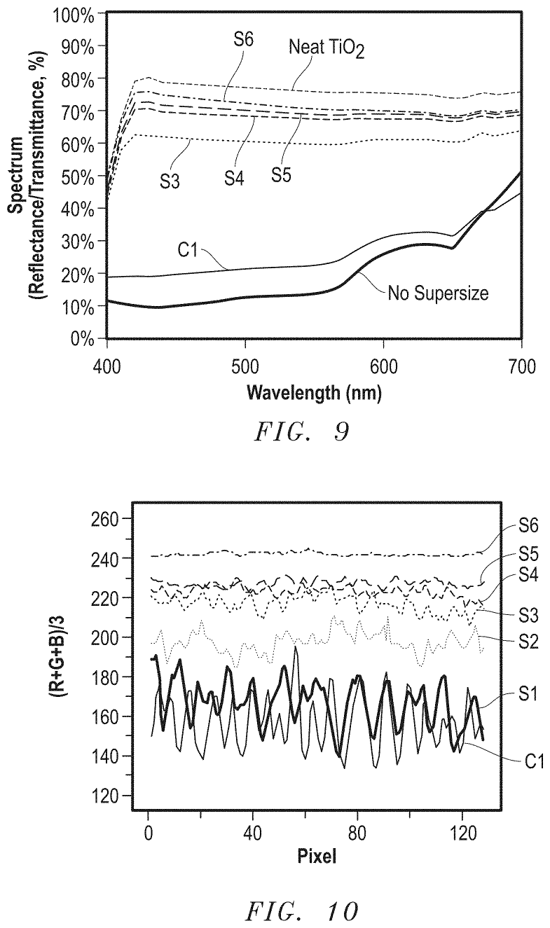

FIG. 7 shows comparative surface images of a conventional abrasive article (C1) and embodiments (S1 to S6) of abrasive articles 100 of the disclosure. FIG. 8 shows the K/S spectrum values, and FIG. 9 shows the R/T spectrum values of the conventional abrasive article (C1) and the embodiments (S3 to S6) of abrasive articles 100 using a HunterLab EZ 45/0 LAV colorimeter test. As shown, the addition of titanium dioxide in the embodiments (S1 to S6) of abrasive articles 100 reduced the visibility of the pattern seen in the conventional abrasive article (C1) that contained no titanium dioxide in the supersize coat. In some embodiments, the addition of 2 grams of titanium dioxide in S1 may reduce the visibility of the pattern in an abrasive article 100. In some embodiments, the addition of 5 grams of titanium dioxide in S2 may result in a substantially patternless appearance. Thus, in some embodiments, the supersize coat and/or the abrasive article may comprise a substantially patternless appearance.

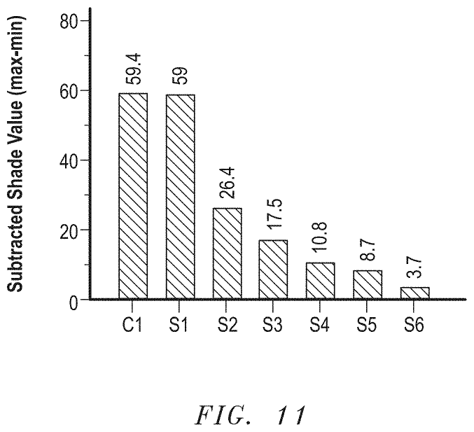

FIG. 10 shows the shade values (using (R+G+B)/3), and FIG. 11 shows the delta shade values (using (R+G+B)/3) of the conventional abrasive article (C1) and the embodiments (S1 to S6) of abrasive articles 100 as measured according to an image processing test. The R, G, and B values are the Red, Green, and Blue values, respectively, from the most common RGB color space, which can be obtained by any image processing software. The shade values of FIG. 10 were determined along a common reference line. The delta shade values of FIG. 11 were determined by subtracting a minimum shade value from a minimum shade value. It is clear that the delta shade value reduced from 59.4 to 3.7 when the patterns in the abrasive articles became less visible. Accordingly, the delta shade values demonstrate the reduction in the patternless appearance of the embodiments (S1 to S6) of abrasive articles 100.

In addition, the addition of titanium dioxide in the embodiments (S1 to S6) of abrasive articles 100 increased the white-colored appearance as compared to the conventional abrasive article (C1) that contained no titanium dioxide in the supersize coat. As shown, it will be appreciated that in some embodiments, a minimum of 5 grams may result in a substantially white appearance based on the shade values and/or the delta shade values. Abrasive articles 100 having at least 5 grams of titanium dioxide in a supersize coat may have a substantially white appearance. Accordingly, in some embodiments, the addition of titanium dioxide and/or increase in titanium dioxide in the supersize coat may reduce the visibility of a pattern and/or increase the white-color appearance of an abrasive article 100. Furthermore, an increase in the amount of titanium dioxide between embodiments (from S1 to S6) may further enhance and/or increase the white-colored appearance of an abrasive article.

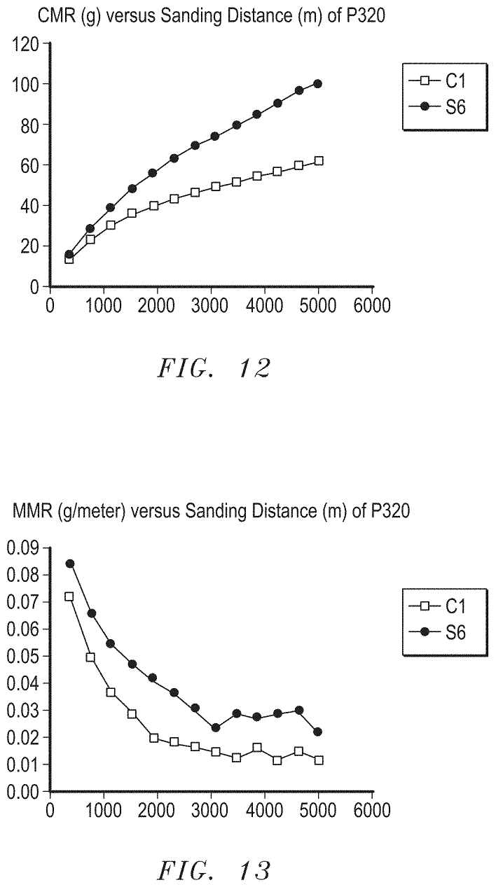

FIGS. 12 and 13 show a chart providing comparative data of cumulative material removal (CMR) versus cycles and cumulative material removal ratio (MRR) versus cycles of a conventional abrasive article (C1) and an embodiment (S6) of an abrasive article 100 of the disclosure. A vibrating sander was used in this test, which is representative and suitable for sanding furniture paints. As shown, S6 has a 62% higher CMR and a higher MRR as compared to C1 for a P320 grit abrasive article.

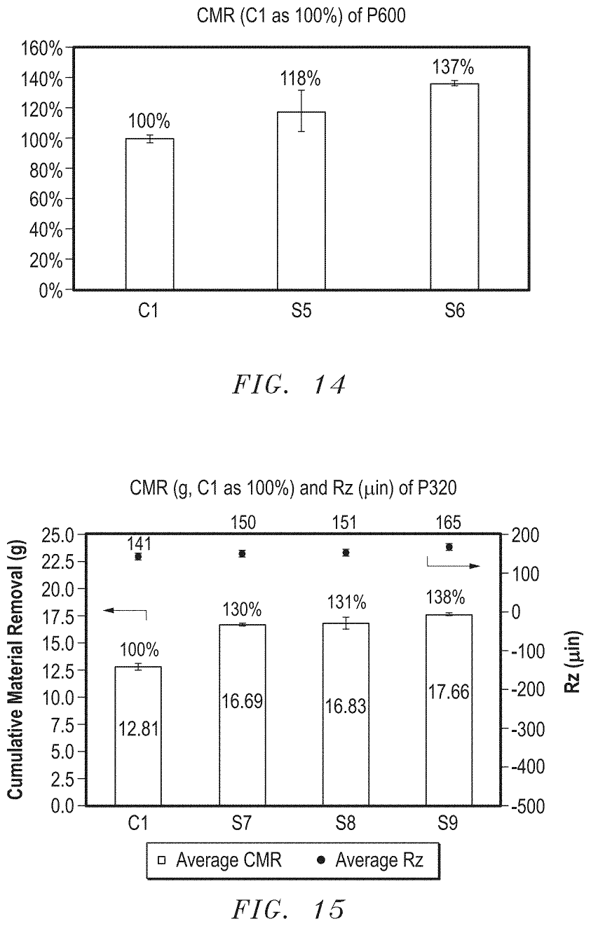

FIG. 14 shows a chart providing comparative data of cumulative material removal (CMR) versus cycles of a conventional abrasive article (C1) and embodiments (S5 and S6) of abrasive articles 100 of the disclosure. The vibrating sander was also used in these tests. As shown, S5 demonstrates an 18% increase in CMR as compared to C1 for a P600 grit abrasive articles. S6 demonstrates a 37% increase in CMR as compared to C1 for a P600 grit abrasive article.

Additional sample abrasive articles S7 to S9 were prepared. The uncured anti-loading compositions are shown in Table 3 below.

TABLE 3
Uncured Anti-loading Composition

| | C1 | S7 | S8 | S9 |
|---|---|---|---|---|
| Zinc Stearate¹ | 90 | 90 | 90 | 90 |
| Binder¹ | 10 | 10 | 5 | 0 |
| TiO₂¹ | 0 | 50 | 50 | 50 |
| Zinc Stearate² | 90.00% | 60.00% | 62.07% | 64.29% |
| Binder² | 10.00% | 6.67% | 3.45% | 0.00% |
| TiO₂² | 0.00% | 33.33 | 34.48% | 35.71% |

¹Uncured wet weight (grams)
²Uncured wet weight percentage (%)

The cured anti-loading compositions for sample abrasive articles S7 to S9 are shown in Table 4 below.

TABLE 4
Cured Anti-loading Composition

| | C1 | S7 | S8 | S9 |
|---|---|---|---|---|
| Zinc Stearate¹ | 45 | 45 | 45 | 45 |
| Binder¹ | 4.5 | 4.5 | 2.25 | 0 |
| TiO₂¹ | 0 | 15 | 30 | 50 |
| Zinc Stearate² | 90.91% | 45.23% | 46.27% | 47.37% |
| Binder² | 9.09% | 4.52% | 2.31% | 0.00% |
| TiO₂² | 0.00% | 50.25% | 51.41% | 52.63% |

¹Cured dry weight (grams)
²Cured dry weight percentage (%)

FIG. 15 shows a chart providing comparative data of average cumulative cut and surface roughness of a conventional abrasive article (C1) and embodiments (S7 to S9) of P320 grit abrasive articles 100 of the disclosure. An orbital sander with a ventilation system was used in this test, which is representative and suitable for sanding automotive paints. More specifically, the charts show the average cumulative cut of the conventional abrasive article (C1) having no titanium dioxide (TiO₂) in their respective supersize coats versus three embodiments (S7 to S9) of abrasive articles 100 having 50 grams of uncured wet weight of titanium dioxide in their respective supersize coats. Surprisingly and beneficially, the sample embodiments (S7 to S9) of abrasive articles 100 had higher average cumulative cut (as measured in percentage) as compared to the conventional abrasive article (C1), ranging from 130% for S7 to 138% for S9. Accordingly, each of S7 to S9 demonstrated at least a 30% improvement over C1, while surface roughness remained relatively constant.

It will be appreciated that embodiments of an abrasive article are disclosed herein that may include one or more of the following embodiments:

Embodiment 1. An abrasive article, comprising: a substrate; an abrasive layer disposed on the substrate; and a secondary layer disposed over the abrasive layer, wherein the secondary layer comprises an anti-loading composition comprising titanium dioxide (TiO₂).

Embodiment 2. The abrasive article of embodiment 1, wherein the abrasive layer comprises at least one of a make coat and a size coat.

Embodiment 3. The abrasive article of embodiment 2, wherein the secondary layer comprises a supersize coat.

Embodiment 4. The abrasive article of embodiment 1, wherein the amount of titanium dioxide in the anti-loading composition comprises at least 0.1 wt. % to not greater than 95 wt. %.

Embodiment 5. The abrasive article of embodiment 4, wherein the amount of titanium dioxide in the anti-loading composition comprises at least 0.1 wt. %, at least 0.5 wt. %, at least 1 wt. %, at least 2 wt. %, at least 3 wt. %, at least 4 wt. %, at least 5 wt. %, at least 6 wt. %, at least 7 wt. %, at least 8 wt. %, at least 9 wt. %, at least 10 wt. %, at least 12 wt. %, at least 13 wt. %, at least 20 wt. %, at least 23 wt. %, at least 25 wt. %, at least 27 wt. %, at least 30 wt. %, at least 33 wt. %, at least 35 wt. %, at least 37 wt. %, at least 40 wt. %, at least 50 wt. %, at least 60 wt. %, or at least 65 wt. %.

Embodiment 6. The abrasive article of embodiment 5, wherein the amount of titanium dioxide in the anti-loading composition comprises not greater than 95 wt. %, not greater than 90 wt. %, not greater than 85 wt. %, not greater than 80 wt. %, not greater than 75 wt. %, not greater than 74 wt. %, not greater than 73 wt. %, not greater than 72 wt. %, not greater than 71 wt. %, or not greater than 70 wt. %.

Embodiment 7. The abrasive article of embodiment 1, wherein the anti-loading agent comprises a metal stearate, a wax lubricant, or a combination thereof.

Embodiment 8. The abrasive article of embodiment 7, wherein the metal stearate comprises calcium stearate, lithium stearate, zinc stearate, hydrate forms thereof, or a combination thereof.

Embodiment 9. The abrasive article of embodiment 8, wherein the amount of metal stearate in the anti-loading composition comprises at least 10 wt. % to not greater than 99 wt. %.

Embodiment 10. The abrasive article of embodiment 9, wherein the amount of metal stearate in the anti-loading composition comprises at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, or at least 75 wt. %.

Embodiment 11. The abrasive article of embodiment 10, wherein the amount of metal stearate in the anti-loading composition comprises not greater than 99 wt. %, not greater than 95 wt. %, not greater than 90 wt. %, not greater than 85 wt. %, or not greater than 80 wt. %.

Embodiment 12. The abrasive article of embodiment 1, wherein the anti-loading composition comprises: 1 to 20 wt. % of a polymeric resin binder; 10 to 80 wt. % of an anti-loading agent; and 10 to 80 wt. % of the titanium dioxide.

Embodiment 13. The abrasive article of embodiment 1, wherein the anti-loading composition further comprises an additive comprising a grinding aid, a fiber, a lubricant, a wetting agent, a thixotropic material, a surfactant, a thickening agent, a pigment, a dye, an antistatic agent, a coupling agent, a plasticizer, a suspending agent, a pH modifier, an adhesion promoter, a lubricant, a bactericide, a fungicide, a flame retardant, a degassing agent, an anti-dusting agent, a dual function material, an initiator, a chain transfer agent, a stabilizer, a dispersant, a reaction mediator, a colorant, a defoamer, or any combination thereof.

Embodiment 14. The abrasive article of embodiment 1, wherein the anti-loading composition further comprises calcium sulfate (CaSO₄), Talc, or a combination thereof.

Embodiment 15. The abrasive article of embodiment 1, wherein the abrasive article comprises a substantially white-colored appearance according to a colorimeter test.

Embodiment 16. The abrasive article of embodiment 1, wherein the abrasive article comprises a substantially patternless appearance according to at least one of a color spectrum test and an image processing test,

Embodiment 17. A method of making an abrasive article, comprising: forming an anti-loading composition comprising titanium dioxide; and disposing the anti-loading composition over an abrasive layer of the coated abrasive article.

Embodiment 18. The method of embodiment 17, wherein the abrasive layer comprises at least one of a make coat and a size coat.

Embodiment 19. The method of embodiment 18, wherein the anti-loading composition comprises a supersize coat.

Embodiment 20. The method of embodiment 17, wherein the amount of titanium dioxide in the anti-loading composition comprises at least 0.1 wt. % to not greater than 95 wt. %.

Embodiment 21. The method of embodiment 20, wherein the amount of titanium dioxide in the anti-loading composition comprises at least 0.1 wt. %, at least 0.5 wt. %, at least 1 wt. %, at least 2 wt. %, at least 3 wt. %, at least 4 wt. %, at least 5 wt. %, at least 6 wt. %, at least 7 wt. %, at least 8 wt. %, at least 9 wt. %, at least 10 wt. %, at least 12 wt. %, at least 13 wt. %, at least 20 wt. %, at least 23 wt. %, at least 25 wt. %, at least 27 wt. %, at least 30 wt. %, at least 33 wt. %, at least 35 wt. %, at least 37 wt. %, at least 40 wt. %, at least 50 wt. %, at least 60 wt. %, or at least 65 wt. %.

Embodiment 22. The method of embodiment 21, wherein the amount of titanium dioxide in the anti-loading composition comprises not greater than 95 wt. %, not greater than 90 wt. %, not greater than 85 wt. %, not greater than 80 wt. %, not greater than 75 wt. %, not greater than 74 wt. %, not greater than 73 wt. %, not greater than 72 wt. %, not greater than 71 wt. %, or not greater than 70 wt. %.

Embodiment 23. The method of embodiment 17, wherein anti-loading composition comprises a metal stearate, a wax lubricant, or a combination thereof.

Embodiment 24. The method of embodiment 23, wherein the metal stearate comprises calcium stearate, lithium stearate, zinc stearate, hydrate forms thereof, or a combination thereof.

Embodiment 25. The method of embodiment 24, wherein the amount of metal stearate in the anti-loading composition comprises at least 10 wt. % to not greater than 99 wt. %.

Embodiment 26. The method of embodiment 25, wherein the amount of metal stearate in the anti-loading composition comprises at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, or at least 75 wt. %.

Embodiment 27. The method of embodiment 26, wherein the amount of metal stearate in the anti-loading composition comprises not greater than 99 wt. %, not greater than 95 wt. %, not greater than 90 wt. %, not greater than 85 wt. %, or not greater than 80 wt. %.

Embodiment 28. The method of embodiment 17, wherein forming the anti-loading composition comprises mixing: 1 to 20 wt. % of a polymeric resin binder; 10 to 80 wt. % of an anti-loading agent; and 10 to 80 wt. % of the titanium dioxide.

Embodiment 29. The method of embodiment 17, wherein forming the anti-loading composition comprises mixing calcium sulfate (CaSO₄), Talc, or a combination thereof.

Embodiment 30. The method of embodiment 17, wherein the abrasive article comprises a substantially white-colored appearance according to a colorimeter test.

Embodiment 31. The method of embodiment 17, wherein the abrasive article comprises a substantially patternless appearance according to at least one of a color spectrum test and an image processing test.

Embodiment 32. A method of making an abrasive article, comprising: providing a substrate; disposing a make coat on the substrate; disposing abrasive particles or aggregates at least partially in or on the make coat; disposing a size coat over the abrasive particles or aggregates and the make coat; and disposing a supersize coat comprising an anti-loading composition over the size coat, wherein the anti-loading composition comprises a polymeric resin binder, an anti-loading agent, and at least one performance component comprising titanium dioxide (TiO₂).

Embodiment 33. The method of embodiment 32, wherein the anti-loading composition comprises: 1 to 20 wt. % of the polymeric resin binder; 10 to 80 wt. % of the anti-loading agent; and 10 to 80 wt. % of the titanium dioxide.

Embodiment 34. The article of embodiment 1 or the method of embodiment 17 or 32, wherein the titanium dioxide comprises auatase, rutile, brookite, or any combination thereof.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. An abrasive article, comprising:
a substrate;
an abrasive layer disposed on the substrate; and
a secondary layer disposed over the abrasive layer, wherein the secondary layer comprises an anti-loading composition comprising titanium dioxide (TiO₂).

2. The abrasive article of claim 1, wherein the abrasive layer comprises at least one of a make coat and a size coat.

3. The abrasive article of claim 2, wherein the secondary layer comprises a supersize coat.

4. The abrasive article of claim 1, wherein the amount of titanium dioxide in the anti-loading composition comprises at least 0.1 wt. % to not greater than 95 wt. %.

5. The abrasive article of claim 1, wherein the amount of titanium dioxide in the anti-loading composition comprises at least 0.1 wt. %, at least 0.5 wt. %, at least 1 wt. %, at least 2 wt. %, at least 3 wt. %, at least 4 wt. %, at least 5 wt. %, at least 6 wt. %, at least 7 wt. %, at least 8 wt. %, at least 9 wt. %, at least 10 wt. %, at least 12 wt. %, at least 13 wt. %, at least 20 wt. %, at least 23 wt. %, at least 25 wt. %, at least 27 wt. %, at least 30 wt. %, at least 33 wt. %, at least 35 wt. %, at least 37 wt. %, at least 40 wt. %, at least 50 wt. %, at least 60 wt. %, or at least 65 wt. %.

6. The abrasive article of claim 5, wherein the amount of titanium dioxide in the anti-loading composition comprises not greater than 95 wt. %, not greater than 90 wt. %, not greater than 85 wt. %, not greater than 80 wt. %, not greater than 75 wt. %, not greater than 74 wt. %, not greater than 73 wt. %, not greater than 72 wt. %, not greater than 71 wt. %, or not greater than 70 wt. %.

7. The abrasive article of claim 1, wherein the anti-loading agent comprises a metal stearate, a wax lubricant, or a combination thereof.

8. The abrasive article of claim 7, wherein the metal stearate comprises calcium stearate, lithium stearate, zinc stearate, hydrate forms thereof, or a combination thereof.

9. The abrasive article of claim 8, wherein the amount of metal stearate in the anti-loading composition comprises at least 10 wt. % to not greater than 99 wt. %.

10. The abrasive article of claim 9, wherein the amount of metal stearate in the anti-loading composition comprises at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, or at least 75 wt. %.

11. The abrasive article of claim 10, wherein the amount of metal stearate in the anti-loading composition comprises not greater than 99 wt. %, not greater than 95 wt. %, not greater than 90 wt. %, not greater than 85 wt. %, or not greater than 80 wt. %.

12. The abrasive article of claim 1, wherein the anti-loading composition comprises:
1 to 20 wt. % of a polymeric resin binder;
10 to 80 wt. % of an anti-loading agent; and
10 to 80 wt. % of the titanium dioxide.

13. The abrasive article of claim 1, wherein the anti-loading composition further comprises an additive comprising a grinding aid, a fiber, a lubricant, a wetting agent, a thixotropic material, a surfactant, a thickening agent, a pigment, a dye, an antistatic agent, a coupling agent, a plasticizer, a suspending agent, a pH modifier, an adhesion promoter, a lubricant, a bactericide, a fungicide, a flame retardant, a degassing agent, an anti-dusting agent, a dual function material, an initiator, a chain transfer agent, a stabilizer, a dispersant, a reaction mediator, a colorant, a defoamer, or any combination thereof.

14. The abrasive article of claim 1, wherein the anti-loading composition further comprises calcium sulfate (CaSO₄), Talc, or a combination thereof.

15. The abrasive article of claim 1, wherein the abrasive article comprises a substantially white-colored appearance according to a colorimeter test.

16. The abrasive article of claim 1, wherein the abrasive article comprises a substantially patternless appearance according to at least one of a color spectrum test and an image processing test.

17. The abrasive article of claim 1, wherein the amount of titanium dioxide in the anti-loading composition comprises at least 2 grams.

18. The abrasive article of claim 17, wherein the amount of titanium dioxide in the anti-loading composition comprises not greater than 60 grams.

19. The abrasive article of claim 1, wherein the titanium dioxide comprises auatase, rutile, brookite, or any combination thereof.

20. A method of making an abrasive article, comprising:
providing a substrate;
disposing a make coat on the substrate;
disposing abrasive particles or aggregates at least partially in or on the make coat;
disposing a size coat over the abrasive particles or aggregates and the make coat; and
disposing a supersize coat comprising an anti-loading composition over the size coat, wherein the anti-loading composition comprises a polymeric resin binder, an anti-loading agent, and at least one performance component comprising titanium dioxide (TiO₂).
